(19) United States
(12) Patent Application Publication
(10) Pub. No.: US 2008/0170056 A1
(43) Pub. Date: Jul. 17, 2008

(54) Plasma display and driving method thereof

(76) Inventor: Sang-Chul Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/987,202

(22) Filed: Nov. 28, 2007

(30) Foreign Application Priority Data
Jan. 17, 2007 (KR) 10-2007-0005189

(51) Int. Cl. G09G 5/00; G09G 3/28

(52) U.S. Cl. 345/205; 345/67

(57) ABSTRACT

A plasma display includes a plasma display panel having a plurality of first electrodes, a plurality of second electrodes, a plurality of third electrodes crossing the first and second electrodes, and discharge cells corresponding to electrode crossings, and a controller configured to control reset, address and sustain operations for a plurality of weighted subfields, and to control a misfire prevention operation, the misfire prevention operation occurring before a main reset operation in a subfield that includes the main reset operation.

### BACKGROUND OF THE INVENTION

1. Field of the Invention

Embodiments relate to a plasma display and a driving method thereof and, more particularly, to a plasma display and a driving method thereof that include a misfire prevention operation.

2. Description of the Related Art

A plasma display is a display device employing a plasma display panel (PDP) configured to display characters and/or images using plasma generated by means of gas discharge. The PDP may include, depending on its size, several tens to millions of discharge cells arranged in a matrix format.

In driving the plasma display, a reset may be performed in a subfield in order to initialize all discharge cells. During the reset, a reset waveform including a gradually increasing ramp pulse and a gradually decreasing ramp pulse may be supplied to a scan electrode in order to initialize all the discharge cells. However, since characteristics of a MgO layer of the PDP may vary when an overall driving time of the plasma display becomes large, a discharge delay may be increased. In this case, when the discharge delay occurs during the rising period of the reset waveform, a reset discharge time between the scan electrode and a sustain electrode may be delayed. This delay may result in a large voltage difference between the scan electrode and the sustain electrode, which may cause a strong discharge between the two electrodes.

When a strong discharge of this kind is generated, resulting in numerous wall charges between the scan electrode and the sustain electrode during the rising voltage period of the reset period, a discharge cell that should not be turned on during a subsequent address period may nonetheless be selected, and misfires may thus be problematically generated during a sustain period that follows the address period.

The description of the related art provided above is not prior art, but is merely a general overview that is provided to enhance an understanding of the art, and does not necessarily correspond to a particular structure or device.

### SUMMARY OF THE INVENTION

Embodiments are therefore directed to a plasma display and a driving method thereof, which substantially overcome one or more of the problems due to the limitations and disadvantages of the related art.

It is therefore a feature of an embodiment to provide a plasma display and a driving method thereof that include a misfire prevention operation, which may provide a reduced discharge delay.

It is therefore another feature of an embodiment to provide a plasma display and a driving method thereof configured to determine an accumulated driving time of the display, and to perform a misfire prevention operation if the accumulated driving time exceeds a predetermined time.

At least one of the above and other features and advantages may be realized by providing a plasma display including a plasma display panel having a plurality of first electrodes, a plurality of second electrodes, a plurality of third electrodes crossing the first and second electrodes, and discharge cells corresponding to electrode crossings, and a controller configured to control reset, address and sustain operations for a plurality of weighted subfields, and to control a misfire prevention operation, the misfire prevention operation occurring before a main reset operation in a subfield that includes the main reset operation. The controller may be configured to determine an accumulated driving time of the plasma display, the controller may perform the misfire prevention operation when the accumulated driving time is greater than a predetermined time, the controller may omit the misfire prevention operation when the accumulated driving time is less than the predetermined time, the main reset operation may initialize all discharge cells, and wherein, during the misfire prevention operation, a first voltage difference may be applied between the first and second electrodes, and a second voltage difference may be applied between the first and third electrodes.

The first voltage difference between the first and second electrodes may be greater than a discharge firing voltage between the first and second electrodes, and the second voltage difference between the first and third electrodes may be greater than a discharge firing voltage between the first and third electrodes.

During the misfire prevention operation, a second voltage that is greater than a first voltage may be supplied to the first electrodes, a third voltage that is lower than the second voltage may be supplied to the third electrodes, and the first voltage may be supplied to the second electrodes. During the main reset operation, a voltage supplied to the first electrodes may increase to a sixth voltage, and the second voltage and the sixth voltage may be the same. During the main reset period, the voltage supplied to the first electrodes may gradually increase from a fifth voltage to the sixth voltage while a fourth voltage is supplied to the second electrodes, and the voltage supplied to the first electrodes may gradually decrease from an eighth voltage that is lower than the sixth voltage to a ninth voltage while a seventh voltage that is greater than the fourth voltage is supplied to the second electrodes. The fourth voltage and the first voltage may be the same.

The main reset operation may occur only during a first subfield of the plurality of subfields. During the misfire prevention operation, a first voltage may be supplied to the first electrodes, a second voltage that is greater than the first voltage may be supplied to the second electrodes, and a third voltage that is greater than the first voltage may be supplied to the third electrodes. The first voltage may be the same as a scan pulse voltage that is supplied to the first electrode of a turn-on discharge cell among the plurality of first electrodes during the address period, the second voltage may be the same as a fourth voltage that is supplied to the plurality of second electrodes during the address period, and the third voltage may be the same as an address voltage supplied to the third electrode of the turn-on discharge cell among the plurality of third electrodes during the address period. Pulse widths of the first and third voltages may be greater than widths of the scan and address pulses respectively supplied to the first and third electrodes of the turn-on discharge cell during the address period.

At least one of the above and other features and advantages may also be realized by providing a method of driving a plasma display having a plurality of first electrodes, a plurality of second electrodes, a plurality of third electrodes crossing the first and second electrodes, and discharge cells corresponding to electrode crossings, in which reset, address and sustain operations are performed for a plurality of weighted subfields, the method including determining an accumulating driving time of the plasma display, performing a misfire prevention operation when the accumulated driving time is greater than a predetermined time, and performing a main reset operation that initializes all discharge cells. The misfire prevention operation may be performed before the main reset operation in a subfield that includes the main reset operation, and the misfire prevention operation may include applying a first voltage difference between the first and second electrodes, and applying a second voltage difference between the first and third electrodes.

The first voltage difference between the first and second electrodes may be greater than a discharge firing voltage between the first and second electrodes, and the second voltage difference between the first and third electrodes may be greater than a discharge firing voltage between the first and third electrodes.

During the misfire prevention operation, a second voltage that is greater than a first voltage may be supplied to the first electrodes, a third voltage that is lower than the second voltage may be supplied to the third electrodes, and the first voltage may be supplied to the second electrodes. During the main reset operation, a voltage supplied to the first electrodes may increase to a sixth voltage, and the second voltage and the sixth voltage may be the same. During the main reset period, the voltage supplied to the first electrodes may gradually increase from a fifth voltage to the sixth voltage while a fourth voltage is supplied to the second electrodes, and the voltage supplied to the first electrodes may gradually decrease from an eighth voltage that is lower than the sixth voltage to a ninth voltage while a seventh voltage that is greater than the fourth voltage is supplied to the second electrodes. The fourth voltage and the first voltage may be the same.

During the misfire prevention operation, a first voltage may be supplied to the first electrodes, a second voltage that is greater than the first voltage may be supplied to the second electrodes, and a third voltage that is greater than the first voltage may be supplied to the third electrodes. The first voltage may be the same as a scan pulse voltage that is supplied to the first electrode of a turn-on discharge cell among the plurality of first electrodes during the address period, the second voltage may be the same as a fourth voltage that is supplied to the plurality of second electrodes during the address period, and the third voltage may be the same as an address voltage supplied to the third electrode of the turn-on discharge cell among the plurality of third electrodes during the address period. Pulse widths of the first and third voltages may be greater than widths of the scan and address pulses respectively supplied to the first and third electrodes of the turn-on discharge cell during the address period. The main reset operation may occur only during a first subfield of the plurality of subfields.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a diagram of a plasma display according to an example embodiment;

FIG. 2 illustrates a flowchart of a driving method according to an example embodiment;

FIG. 3 illustrates driving waveforms according to a first example embodiment;

FIG. 4 illustrates effects of driving waveforms that lack a misfire prevention operation; and

FIG. 5 illustrates driving waveforms according to a second example embodiment.

### DETAILED DESCRIPTION OF THE INVENTION

Korean Patent Application No. 10-2007-0005189, filed on Jan. 17, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Throughout this specification and the claims which follow, unless explicitly described to the contrary, the words “comprise” and “include” and variations such as “comprises,” “comprising,” “includes” and “including” will be understood to encompass any stated elements and not to exclude additional elements.

In addition, “wall charges” described herein mean charges formed and accumulated on a wall, e.g., a dielectric layer, close to an electrode of a discharge cell. A wall charge may be described as being “formed on” or “accumulated on” the electrode, although the wall charges may not actually touch the electrode. Further, a “wall voltage” means a potential difference formed on the wall of the discharge cell by the wall charge.

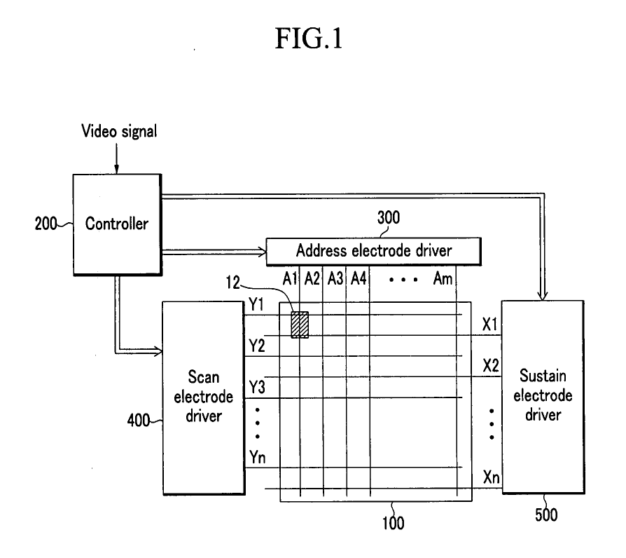

FIG. 1 illustrates a diagram of a plasma display according to an example embodiment.

As shown in FIG. 1, the plasma display may include a plasma display panel (PDP) 100, a controller 200, an address electrode driver 300, a scan electrode driver 400, and a sustain electrode driver 500.

The PDP 100 may include a plurality of address electrodes A1 to Am, which may extend in a column direction. The PDP 100 may further include a plurality of sustain electrodes X1 to Xn and a plurality of scan electrodes Y1 to Yn in pairs extending in a row direction, such that each sustain electrode X may respectively correspond to a scan electrode Y. Ends of the sustain electrodes X1 to Xn may be connected in common. The address electrodes A1 to Am may be formed to cross the sustain electrodes X1 to Xn and the scan electrode Y1 to Yn. Discharge spaces, e.g., discharge cells 12, may be formed in areas where the A electrodes A1 to Am cross the X and Y electrodes X1 to Xn and Y1 to Yn.

The controller 200 may receive external video signals and may output address, sustain electrode, and scan electrode driving control signals. In addition, the controller 200 may divide a field or frame into a plurality of subfields, which may be respectively weighted. During each subfield, a reset operation, an address operation, and a sustain operation may be performed during a reset period, an address period, and a sustain period, respectively, of the subfield.

Further, the controller 200 may control one or more drivers to perform a misfire prevention operation during a misfire prevention period. The misfire prevention period may be part of a first subfield of the field. The misfire prevention period may precede a main reset period of the first subfield. In an implementation, the misfire prevention operation may be performed or omitted, i.e., not performed, based on an accumulated driving time of the plasma display. In an implementation, the controller 200 may accumulate a driving time of the plasma display and calculate the accumulated driving time. Subsequent subfields of the field may include an auxiliary reset period instead of the misfire prevention period and the main reset period. The misfire prevention operation is described in additional detail below.

In driving the PDP 100, one field may be divided by the controller 200 into a plurality of subfields, each having a weight value, and a grayscale may be embodied by performing time-divisional control of the subfields. Each subfield may include the reset period, the address period, and the sustain period. The reset period may be a period of initializing a state of each cell so as to smoothly perform an address operation in a cell, and the address period may be a period of selecting, through an address discharge, a cell that is to emit light from among the plurality of cells. In addition, the sustain period may be a period of performing a sustain discharge in a cell that is to emit light.

After receiving an address driving control signal from the controller 200, the address electrode driver 300 may supply a display data signal, for selecting discharge cells to be displayed, to the respective address electrodes A1 to Am.

The scan electrode driver 400 may receive scan electrode driving control signals from the controller 200, and may supply a driving voltage to the scan electrodes.

The sustain electrode driver 500 may receive sustain electrode driving control signals from the controller 200, and may supply a driving voltage to the sustain electrodes.

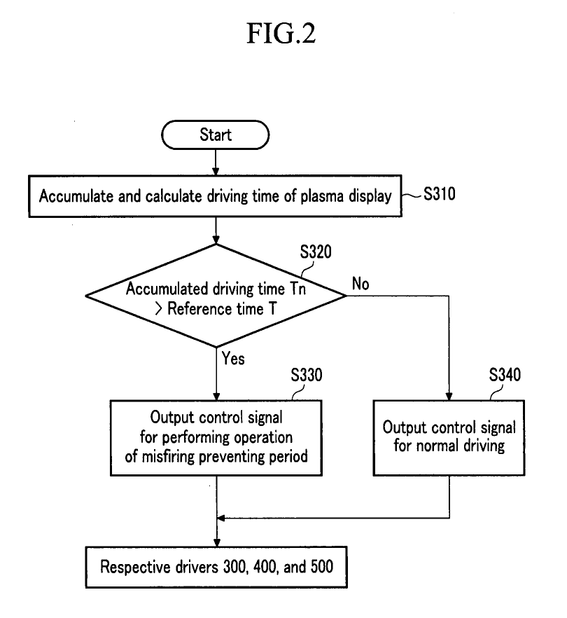

FIG. 2 illustrates a flowchart of a driving method according to an example embodiment. In this example embodiment, various operations will be described as being performed by the controller 200. However, it will be appreciated that some or all of the operations may be performed by one or more other components, and may be preformed using one or more of hardware, software, firmware, etc.

As shown in FIG. 2, in operation 310, the controller 200 may accumulate a driving time of the plasma display and may calculate the driving time. In operation S320, the controller 200 may compare an accumulated driving time Tn with a predetermined reference time T.

In operation S330, if the accumulated driving time Tn is greater than the reference time T, the controller 200 may output control signals for performing the misfire prevention operation to the respective drivers 300, 400, and 500.

In operation S340, if the accumulated driving time Tn is less than the reference time T, the controller 200 may output control signals for performing a normal operation to the respective drivers 300,400, and 500. The normal driving operation may provide the reset, address, and sustain periods in one field. More particularly, the normal driving operation may provide the main reset operation in one or more subfields in the one field, and may provide the auxiliary reset operation in remaining subfields of the one field.

For convenience and clarity of description, in the example embodiments described herein, the normal driving operation provides the main reset only in the first subfield of the field. However, it will be appreciated that the main reset may be performed in a subfield other than the first subfield, or in one or more subfields different from, or in addition to, the first subfield. Further, driving waveforms supplied to the Y, X, and A electrodes of a single discharge cell 12 will be described. However, it will be appreciated that the other Y, X, and A electrodes of the PDP 100 may be driven in a like manner.

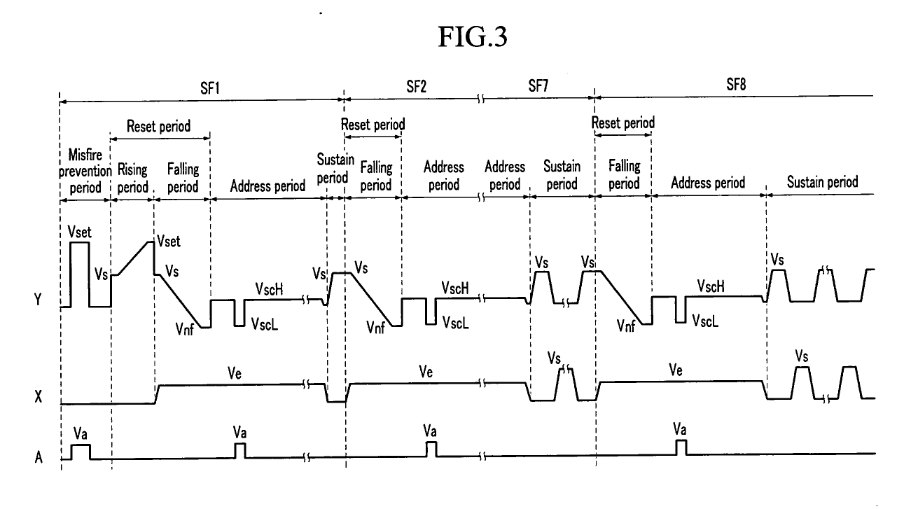

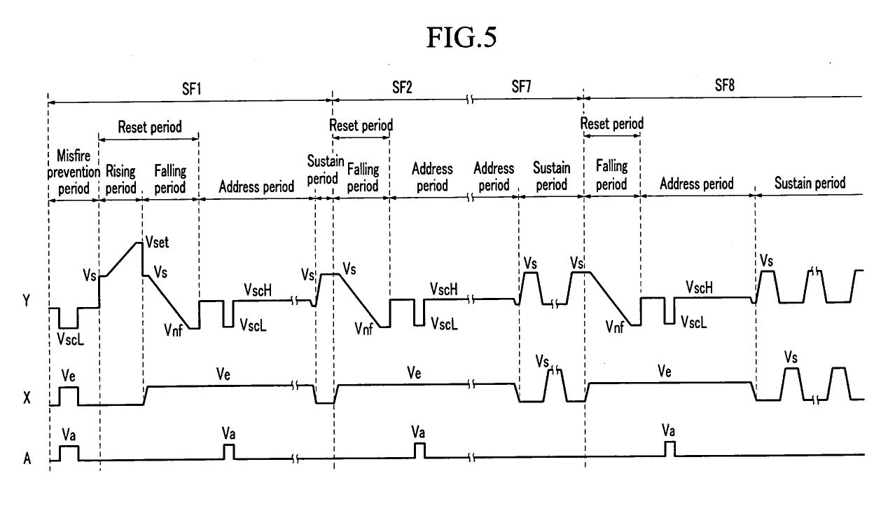

The misfire prevention operation of the plasma display according to first and second example embodiments will be described with reference to FIG. 3 and FIG. 5, respectively. A driving method for driving one field while dividing the one field into eight subfields will be used as an example, in which the main reset operation initializes all discharge cells, and the auxiliary reset operation initializes cells in which the sustain discharge was generated in a previous subfield. In particular, the main reset operation may provide a reset period including a reset waveform having a rising period and a falling period, whereas the auxiliary reset operation may provide a reset period including a reset waveform having the falling period alone.

FIG. 3 illustrates driving waveforms according to a first example embodiment.

As shown in FIG. 3, in the plasma display according to the first example embodiment, when the accumulated driving time Tn is greater than the predetermined reference time T, the misfire prevention period may be provided before the rising period of the main reset period of the first subfield SF1.

In further detail, during the misfire prevention period, a pulse, e.g., a square pulse, having a voltage Vset may be supplied to the Y electrode, and a pulse, e.g., a square pulse, having a voltage Va may be supplied to the A electrode. In addition, a reference voltage, e.g., 0V, may be maintained at the X electrode during the misfire prevention period. In this case, the voltage Va and the voltage Vset respectively supplied to the A electrode and the Y electrode may be set to have the same pulse width.

A voltage difference corresponding to the voltage Vset may be applied between the Y electrode and the X electrode, and a discharge may be generated by the voltage difference of the Vset between the Y electrode and the X electrode. In particular, negative (−) wall charges may be formed on the scan electrode, and positive (+) wall charges may be formed on the sustain electrode. Since the voltage Va may be supplied to the address electrode, a voltage difference of (Vset−Va) may be applied between the Y electrode and the A electrode, and the positive (+) wall charges may be formed on the A electrode to be less than the wall charges formed in the X electrode. In this case, when the voltage difference between the Y and X electrodes becomes 0V, enough wall charges may be formed to generate a discharge in the Y electrode and the X electrode. Accordingly, when the voltage difference between the Y and X electrodes becomes 0V after the square pulse having the voltage Vset is supplied to the Y electrode during the misfire prevention period, a self-erasing discharge may be generated, and the wall charges accumulated in the Y electrode and the X electrode may be eliminated.

As described above, a self-erasing discharge may be generated between the Y and X electrodes during the misfire prevention period, the number of priming particles may be increased in the discharge cell 12 of the PDP 100 while the discharge is generated between the Y electrode and the A electrode, and therefore a discharge delay during the reset period may be reduced.

In an implementation, the voltage Vset supplied to the Y electrode during the misfire prevention period may be substantially equal to a voltage supplied to the Y electrode during the rising period of the subsequent main reset period, and the voltage Vset may be high enough to generate the reset discharge in all the discharge cells. Further, the voltage Va supplied to the A electrode during the misfire prevention period may be substantially equal to an address pulse voltage supplied to the A electrode during a subsequent address period. Since the voltage Vset and the voltage Va respectively supplied to the Y electrode and the A electrode during the misfire prevention period may be the same as voltages supplied during the reset and address periods, the number of driving power sources in the plasma display may be reduced. It will be appreciated, however, that other implementations may be used and other voltages, e.g., a voltage forming a voltage difference that is greater than a discharge firing voltage Vf between the Y and X electrodes, and a voltage forming a voltage difference that is greater than a discharge firing voltage Vf between the Y and A electrodes, may be supplied to the respective electrodes during the misfire prevention period in order to generate discharge between the respective electrodes.

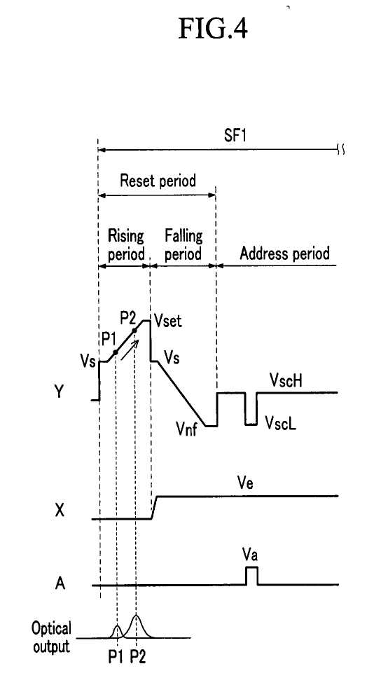

FIG. 4 illustrates effects of driving waveforms that lack a misfire prevention operation. As shown in FIG. 4, a gradually increasing ramp pulse and a gradually decreasing ramp pulse may be supplied to the scan electrode Y to initialize all the discharge cells. Subsequently, during auxiliary reset periods in the remaining subfields, only the gradually decreasing ramp pulse may be supplied to the scan electrode, in order to initialize the cells in which the sustain discharge was generated in the previous subfield. However, since characteristics of the MgO layer may vary when a driving time of the plasma display becomes large, a discharge delay may be generated during a rising period of the main reset period, such that a reset discharge time between the scan electrode Y and a sustain electrode X is moved from a time P1 to a time P2. Since a voltage difference between the scan electrode Y and the sustain electrode X at the time P2 may be a high voltage that is greater than a discharge firing voltage, a strong discharge may undesirably be generated between the two electrodes, as shown by the optical outputs corresponding to P1 and P2 in FIG. 4.

Referring again to the first example embodiment in FIG. 3, during the main reset period of the first subfield SF1, after the misfire prevention operation, voltages at the X electrode and the A electrode may be maintained at the reference voltage, e.g., 0V, during the rising period of the main reset period, while a voltage at the Y electrode may be gradually increased from a voltage Vs to the voltage Vset. As described above, since a weak discharge may be generated between the Y electrode and the X electrode and between the Y electrode and the A electrode while the voltage at the Y electrode increases, negative (−) wall charges may be formed on the Y electrode and positive (+) wall charges may be formed on the X electrode and the A electrode.

During the falling period of the main reset period of the first subfield SF1, the voltages at the A and X electrodes may be maintained at the reference voltage and a voltage Ve, respectively, and the voltage at the Y electrode may be gradually decreased from the voltage Vs to a voltage Vnf. This may generate a weak discharge between the Y electrode and the X electrode, and between the Y electrode and the A electrode, while the voltage at the Y electrode decreases, and therefore the negative (−) wall charges formed on the Y electrode and the positive (+) wall charges formed on the X electrode and the A electrode may be eliminated. Generally, a voltage difference of (Vnf−Ve) may be set to be close to a discharge firing voltage Vfxy between the Y electrode and the X electrode. Then, a wall voltage between the Y electrode and the X electrode may be nearly 0V, and therefore misfires during the sustain period may be reduce or prevented from occurring in discharge cells in which an address discharge is not generated during the address period.

During the address period of the first subfield SF1, to select a turn-on discharge cell, i.e., a discharge cell to be turned on so as to emit light, a scan pulse having a voltage VscL may be sequentially supplied to the plurality of Y electrodes while the voltage Ve is supplied to the X electrodes. The address pulse having the voltage Va may be supplied to the A electrode corresponding the discharge cell to be turned-on from among the plurality of discharge cells corresponding to the X electrode and the Y electrode to which the VscL voltage is supplied. Thus, the address discharge may be generated between the A electrode to which the voltage Va is supplied and the Y electrode to which the voltage VscL is supplied, and between the Y electrode to which the voltage VscL is supplied and the X electrode to which the voltage Ve voltage is supplied. Accordingly, the positive (+) wall charges may be formed on the Y electrode, and the negative (−) wall charges may be formed on the A electrode and the X electrode. Here, a VscH voltage (non-scan voltage) that may be higher than the VscL voltage may be supplied to Y electrodes to which the VscL voltage is not supplied, and the reference voltage may be supplied to A electrodes of discharge cells that are not selected to be turned-on.

During the sustain period of the first subfield SF1, sustain pulses of alternating phases, which may have a high level voltage, e.g., Vs, and a low level voltage, e.g., 0V, may be supplied to the Y electrode and the X electrode. Thus, the voltage Vs may be supplied to the Y electrode, the 0V voltage may be supplied to the X electrode, and sustain discharge may be generated between the Y electrode and the X electrode. Negative (−) wall charges and positive (+) wall charges may be respectively formed on the Y electrode and the X electrode by the sustain discharge. The sustain pulse may be supplied to the Y electrode and the X electrode a number of times corresponding to a weight value of the subfield. Generally, the sustain pulse may be a waveform, e.g., a square or other shape pulse, having a sustain voltage Vs.

When the first subfield SF1 is finished, the second subfield SF2 may be started. The address period and sustain period operations of the second subfield SF2 may be the same as those of the first subfield SF1. Accordingly, the address period and sustain period operations of the second subfield SF2 will not be repeated below, and only an operation of the reset period will be described.

The reset period of the second subfield SF2 may be an auxiliary reset period, which may include only the falling period of the main reset period of the first subfield SF1. During the falling period, while the voltages at the A electrode and the X electrode are respectively maintained at the reference voltage and the voltage Ve, the voltage at the Y electrode may be gradually decreased from the voltage Vs to the voltage Vnf. Thus, a weak discharge may be generated between the Y electrode and the X electrode, and between the Y electrode and the A electrode, while the voltage at the Y electrode decreases, and negative (−) wall charges formed on the Y electrode and positive (+) wall charges formed on the X electrode and the A electrode may be eliminated. Accordingly, in the second subfield SF2 including the reset period formed by the falling period, the reset discharge may be generated when the sustain discharge is generated in the previous subfield, and the reset discharge may be not generated when the sustain discharge is not generated in the previous subfield.

Operations of the reset, address, and sustain periods in the third to eighth subfields SF3 to SF8 may be same as those of the second subfield SF2, and therefore detailed descriptions thereof will not be repeated. Further, a first sustain pulse and a last sustain pulse of the sustain period of the previous subfield of the respective reset periods of the second to eighth subfields SF2 to SF8 may be the same.

FIG. 5 illustrates driving waveforms according to a second example embodiment.

The driving waveforms in FIG. 5 may be the same as those in FIG. 3, except for a driving waveform of the misfire prevention period, and therefore detailed descriptions of those portions of the waveforms that are the same will not be repeated.

As shown in FIG. 5, in the plasma display according to the second example embodiment of the present invention, when the accumulated driving time Tn is greater than the predetermined reference time T, the misfire prevention period may be provided before the rising period of the main reset period in the first subfield SF1.

In further detail, during the misfire prevention period, a pulse, e.g., a square pulse, having the voltage VscL may be supplied to the Y electrode, a pulse, e.g., a square pulse, having the voltage Va may be supplied to the A electrode, and a pulse, e.g., a square pulse, having the voltage Ve may be supplied to the X electrode. In this case, the voltage VscL, the voltage Va, and the voltage Ve respectively supplied to the Y electrode, the A electrode, and the X electrode during the misfire prevention period may have the same levels as the scan pulse voltage, the address pulse voltage, and the voltage Ve that are respectively supplied during the address period. In an implementation, a pulse width of the VscL voltage square pulse supplied to the Y electrode during the misfire prevention period may be greater than that of the scan pulse supplied to the Y electrode during the address period. Thus, discharge may be more efficiently generated. In addition, the pulse widths of the VscL, Va, and Ve voltage square pulses respectively supplied to the Y, A, and X electrodes during the misfire prevention period may be set to be equal during the misfire prevention period.

As described above, a voltage difference of (Va−VscL) may be applied between the Y electrode and the A electrode. The voltage difference of (Va−VscL) may be greater than a discharge firing voltage between the Y electrode and the A electrode, and therefore discharge may be generated between the Y electrode and the A electrode. In addition, a voltage difference of (Ve−VscL) may be applied between the Y electrode and the X electrode, and discharge may be generated between the Y electrode and the X electrode, since the voltage difference (Ve−VscL) may be greater than a discharge firing voltage between the two electrodes.

Generally, a sum of the wall voltage formed between the respective electrodes and the voltage difference of (Va−VscL) or the voltage difference of (Ve−VscL) may be greater than the discharge firing voltage. In the second example embodiment, the wall voltages between the respective electrodes during the address period may be nearly 0V, and the voltages VscL, Ve, and Vas may be respectively supplied to the Y, X, and A electrodes during the misfire prevention period. However, when the wall voltages formed between the respective electrodes during the address period are greater than 0V, voltages other than the VscL, Ve, and Voltage Vas may be supplied to the Y, X, and A electrodes during the misfire prevention period to generate the discharges between the Y electrode and the X electrode, and between the Y electrode and the A electrode. In addition, in the second example embodiment, since the voltages VscL, Ve, and Vas may be respectively supplied to the Y, X, and A electrodes during the address period, the number of driving power sources may be reduced.

As described above, the priming particles may increase in the discharge space of the PDP 100 while the discharge is generated between the Y electrode and the A electrode, and between the Y electrode and the X electrode, during the misfire prevention period, and the discharge delay during the reset period may be reduced. In addition, since the discharges generated between the respective electrodes during the misfire prevention period may be initialized during a subsequent main reset period, the discharges may not affect subsequent address and sustain periods. Further, since the misfire prevention period may be provided before the main reset period as the accumulated driving time of the plasma display increases, priming particles may be compensated and a discharge delay may be reduced.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display, comprising:
a plasma display panel having a plurality of first electrodes, a plurality of second electrodes, a plurality of third electrodes crossing the first and second electrodes, and discharge cells corresponding to electrode crossings; and
a controller configured to control reset, address and sustain operations for a plurality of weighted subfields, and to control a misfire prevention operation, the misfire prevention operation occurring before a main reset operation in a subfield that includes the main reset operation, wherein:
the controller is configured to determine an accumulated driving time of the plasma display,
the controller performs the misfire prevention operation when the accumulated driving time is greater than a predetermined time,
the controller omits the misfire prevention operation when the accumulated driving time is less than the predetermined time,
the main reset operation initializes all discharge cells, and
wherein, during the misfire prevention operation, a first voltage difference is applied between the first and second electrodes, and a second voltage difference is applied between the first and third electrodes.

2. The plasma display as claimed in claim 1, wherein:
the first voltage difference between the first and second electrodes is greater than a discharge firing voltage between the first and second electrodes, and
the second voltage difference between the first and third electrodes is greater than a discharge firing voltage between the first and third electrodes.

3. The plasma display as claimed in claim 1, wherein, during the misfire prevention operation, a second voltage that is greater than a first voltage is supplied to the first electrodes, a third voltage that is lower than the second voltage is supplied to the third electrodes, and the first voltage is supplied to the second electrodes.

4. The plasma display as claimed in claim 3, wherein, during the main reset operation, a voltage supplied to the first electrodes increases to a sixth voltage, and the second voltage and the sixth voltage are the same.

5. The plasma display as claimed in claim 4, wherein, during the main reset period, the voltage supplied to the first electrodes gradually increases from a fifth voltage to the sixth voltage while a fourth voltage is supplied to the second electrodes, and
the voltage supplied to the first electrodes gradually decreases from an eighth voltage that is lower than the sixth voltage to a ninth voltage while a seventh voltage that is greater than the fourth voltage is supplied to the second electrodes.

6. The plasma display as claimed in claim 5, wherein the fourth voltage and the first voltage are the same.

7. The plasma display as claimed in claim 1, wherein the main reset operation occurs only during a first subfield of the plurality of subfields.

8. The plasma display as claimed in claim 1, wherein, during the misfire prevention operation, a first voltage is supplied to the first electrodes, a second voltage that is greater than the first voltage is supplied to the second electrodes, and a third voltage that is greater than the first voltage is supplied to the third electrodes.

9. The plasma display as claimed in claim 8, wherein:
the first voltage is the same as a scan pulse voltage that is supplied to the first electrode of a turn-on discharge cell among the plurality of first electrodes during the address period,
the second voltage is the same as a fourth voltage that is supplied to the plurality of second electrodes during the address period, and
the third voltage is the same as an address voltage supplied to the third electrode of the turn-on discharge cell among the plurality of third electrodes during the address period.

10. The plasma display as claimed in claim 9, wherein pulse widths of the first and third voltages are greater than widths of the scan and address pulses respectively supplied to the first and third electrodes of the turn-on discharge cell during the address period.

11. A method of driving a plasma display having a plurality of first electrodes, a plurality of second electrodes, a plurality of third electrodes crossing the first and second electrodes, and discharge cells corresponding to electrode crossings, in which reset, address and sustain operations are performed for a plurality of weighted subfields, the method comprising:
determining an accumulating driving time of the plasma display;
performing a misfire prevention operation when the accumulated driving time is greater than a predetermined time; and
performing a main reset operation that initializes all discharge cells, wherein:
the misfire prevention operation is performed before the main reset operation in a subfield that includes the main reset operation, and
the misfire prevention operation includes applying a first voltage difference between the first and second electrodes, and applying a second voltage difference between the first and third electrodes.

12. The method as claimed in claim 11, wherein:
the first voltage difference between the first and second electrodes is greater than a discharge firing voltage between the first and second electrodes, and
the second voltage difference between the first and third electrodes is greater than a discharge firing voltage between the first and third electrodes.

13. The method as claimed in claim 11, wherein, during the misfire prevention operation, a second voltage that is greater than a first voltage is supplied to the first electrodes, a third voltage that is lower than the second voltage is supplied to the third electrodes, and the first voltage is supplied to the second electrodes.

14. The method as claimed in claim 13, wherein, during the main reset operation, a voltage supplied to the first electrodes increases to a sixth voltage, and the second voltage and the sixth voltage are the same.

15. The method as claimed in claim 14, wherein, during the main reset period, the voltage supplied to the first electrodes gradually increases from a fifth voltage to the sixth voltage while a fourth voltage is supplied to the second electrodes, and
the voltage supplied to the first electrodes gradually decreases from an eighth voltage that is lower than the sixth voltage to a ninth voltage while a seventh voltage that is greater than the fourth voltage is supplied to the second electrodes.

16. The method as claimed in claim 15, wherein the fourth voltage and the first voltage are the same.

17. The method as claimed in claim 11, wherein, during the misfire prevention operation, a first voltage is supplied to the first electrodes, a second voltage that is greater than the first voltage is supplied to the second electrodes, and a third voltage that is greater than the first voltage is supplied to the third electrodes.

18. The method as claimed in claim 17, wherein:
the first voltage is the same as a scan pulse voltage that is supplied to the first electrode of a turn-on discharge cell among the plurality of first electrodes during the address period,
the second voltage is the same as a fourth voltage that is supplied to the plurality of second electrodes during the address period, and
the third voltage is the same as an address voltage supplied to the third electrode of the turn-on discharge cell among the plurality of third electrodes during the address period.

19. The method as claimed in claim 18, wherein pulse widths of the first and third voltages are greater than widths of the scan and address pulses respectively supplied to the first and third electrodes of the turn-on discharge cell during the address period.

20. The method as claimed in claim 11, wherein the main reset operation occurs only during a first subfield of the plurality of subfields.
